(19) United States
(12) Patent Application Publication
(10) Pub. No.: US 2012/0095961 A1
(43) Pub. Date: Apr. 19, 2012

(54) TOOL TRACKING SYSTEM AND METHOD

(75) Inventors: Lance MEYER, Hudson, OH (US); Michael SMITH, Akron, OH (US); Michael C. VAJSKOP, Broadview Hts., OH (US)

(73) Assignee: MYERS TIRE SUPPLY INTERNATIONAL, INC., Akron, OH (US)

(21) Appl. No.: 12/905,555

(22) Filed: Oct. 15, 2010

(51) Int. Cl. G06F 17/00

(52) U.S. Cl. 707/634; 707/E17.005

(57) ABSTRACT

A method for tracking a status of a plurality of tools for a plurality of users includes receiving, at a computer, data related to a tool. The data includes a tool identifier, an associated user, location data, and maintenance history data. The method further includes storing the data related to the tool in a database, identifying a date of a future maintenance event, and transmitting a notification to the associated user when the date of the future maintenance event is within a predetermined period of time of a current date. The method also includes receiving updated location data and updated maintenance history data, and storing this data in the database.

### FIELD OF INVENTION

The present application relates to the field of object status and location management. More particularly, the present application relates to a system and method for tracking maintenance status and location of a tool, such as a torque wrench.

### BACKGROUND

A tool is a device that can be used to produce or achieve something, but that is not consumed in the process. In different industries, tools require periodic maintenance to extend the useful life of a tool. In some industries, periodic calibration is required for the tool to be certified by a standard setting body. For example, torque wrenches require annual calibration to receive a certificate of calibration from the American National Standards Institute (ANSI) or the National Institute of Standards and Technology (NIST).

Systems for tracking the location or status of an object are known in the art.

### SUMMARY OF THE INVENTION

A method for tracking a status of a plurality of tools for a plurality of users includes receiving, at a computer, data related to a tool. The data includes a tool identifier, an associated user, location data, and maintenance history data. The method further includes storing the data related to the tool in a database, identifying a date of a future maintenance event, and transmitting a notification to the associated user when the date of the future maintenance event is within a predetermined period of time of a current date. The method also includes receiving updated location data and updated maintenance history data, and storing this data in the database.

### BRIEF DESCRIPTION OF THE DRAWINGS

In the accompanying drawings, structures are illustrated that, together with the detailed description provided below, describe exemplary embodiments of the claimed invention.

In the drawings and description that follows, like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing of one embodiment of a tool tracking system;

FIG. 2 is a schematic drawing of one embodiment of a tool tracking network;

FIG. 3 is a flow chart showing a method for tracking data related to a tool; and

FIG. 4 is a flow chart showing a method for maintaining a tool.

### DETAILED DESCRIPTION

“Data communication,” as used herein, refers to a communication between two or more computing devices (e.g., computer, personal digital assistant, mobile telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), an local area network (“LAN”), a wide area network (“WAN”), a point-to-point system, a circuit switching system, a packet switching system, combinations thereof, and so on.

“Database,” as used herein, refers to a physical or logical entity that can store data. A database may be, for example, a data bank, a table, a file, a list, a queue, a heap, a memory, a register, and so on. A database may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

A “network,” as used herein, includes any mobile or telecommunications network of computing devices, including handheld devices. Exemplary networks include an LAN, a WAN, the Internet, cellular networks, communications satellites, other wireless networks, and Internet protocol telephony.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

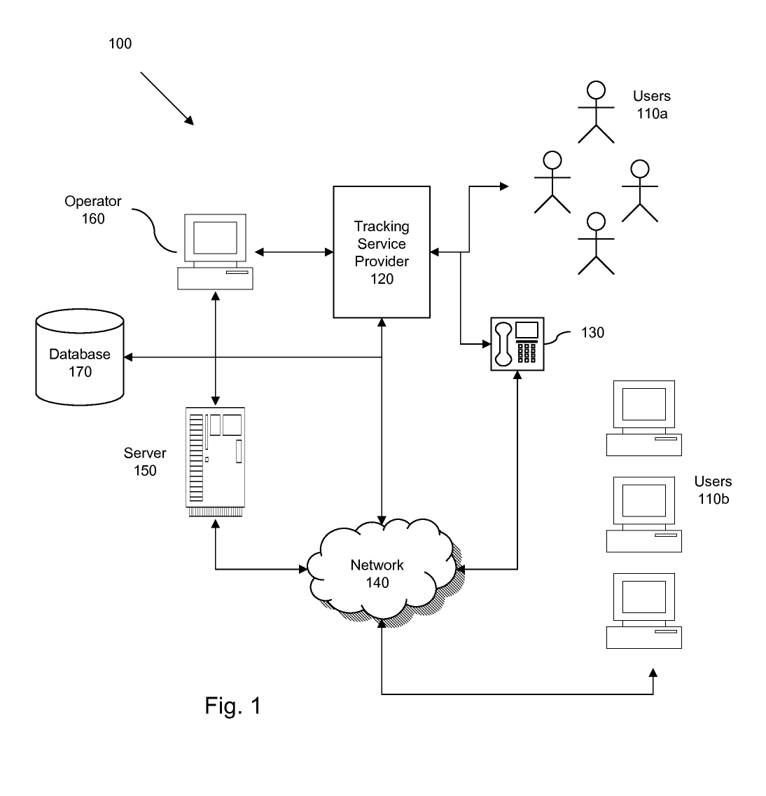

FIG. 1 illustrates a schematic drawing of one embodiment of a tool tracking system 100 for a plurality of users 110a,b having a plurality of tools (not shown). The tool tracking system 100 tracks information related to tools, such as maintenance data and location data. In one particular embodiment, the tool tracking system 100 tracks the location and calibration status of torque wrenches.

The tool tracking system 100 includes a tracking service provider 120. The tracking service provider 120 may be a computer, an automated system, an individual, an association of individuals, or a combination thereof. Users 110a communicate with the tracking service provider 120 through oral or written communication, postal communication, or a telephone 130 in person, or in person. It should be understood that telephone 130 may include landline telephones, cordless telephones, mobile phones, and smart phones. The telephone 130 is operably connected to the tracking service provider 120 through any known means, such as telephone lines, fiberoptic cables, microwave transmissions, undersea telephone cables, or a network 140 that is operably connected to the tracking service provider 120. Additionally, users 110b communicate with the tracking service provider 120 through the network 140. In one embodiment, the tracking service provider 120 is directly connected to the network 140. In an alternative embodiment, the tracking service provider 120 is connected to the network 140 through a server 150.

The tracking service provider 120 is also in data communication with an operator 160. The operator 160 may be a person, a group of people, an automated system, or a semi-automated system. In one embodiment, the operator 160 operates an input device, such as a personal computer, a laptop computer, a tablet computer, a smart phone, or other known input device. In one embodiment, the tracking service provider 120 and the operator 160 are the same entity. Both the service provider 120 and the operator 160 are in data communication with the server 150 and a database 170. Although the server 150 and database 170 are illustrated as separate components, it should be understood that the database 170 may be part of the server.

In operation, users 110a,b provide data that is stored on at least one of the server 150 and the database 170. In one embodiment, the data provided by the users 110a,b is data related to at least one of a plurality of tools. In one particular embodiment, the data is related to at least one of a plurality of torque wrenches.

Data is provided in a data set or a plurality of data sets. Each data set includes a unique identifier that identifies a specific tool. The unique identifier may be a serial number assigned by a manufacturer or an identifier created by a user 110a,b. Each data set also includes location data and maintenance history associated with the specific tool. Maintenance history data may include information related to prior repairs or information related to prior calibration or certification.

Data may be provided by the users 110a,b in multiple ways. In one example, a user 110a is an individual, such as a mechanic or a manager of a maintenance service provider, and the tracking service provider 120 includes one or more individuals, such as a sales representative or a customer service representative. In this example, the individual user may converse with the individual from the tracking service provider 120, and orally provide the data. Such a conversation may occur in person or telephonically. Alternatively, the individual user may provide the date in writing, such as through a postal service, facsimile, email communication, or other electronic communication. As another alternative, an individual from the tracking service provider 120 may travel to the user's location and collect the data. The individual from the tracking service provider 120 may manually gather the data, or may employ a bar code reader or other electronic means to obtain the data directly from the tools. The bar code reader or other electronic means may transmit the data through the network 140, or it may store the data for later retrieval.

After the tracking service provide 120 obtains the data, the data is then input to one of the server 150 and the database 170 through an input device. In one embodiment the individual from the tracking service provider 120 communicates the data to an operator 160, and the operator 160 inputs the data through an input device operably connected to one of the server 150 and the database 170. In an alternative embodiment, the individual from the tracking service provider 120 inputs the data through an input device operably connected to one of the server 150 and the database 170. In another alternative embodiment, where the data is gathered by a barcode reader or other electronic means, the barcode reader or other electronic means may also be an input device that uploads data to one of the server 150 and the database 170.

In another example, a user 110b may use a computer or other networked device to communicate data through the network 140 to the server 150 or database 170. In one embodiment, the user 110b manually enters the data through a website or software application on the computer or other networked device. In an alternative embodiment, the individual user or an individual from the tracking service provider 120 may employ a bar code reader or other electronic means to obtain the data directly from the tools. The bar code reader or other electronic means may be wirelessly connected to the network 140 or connected to the network 140 through one or more cables. Alternatively, the bar code reader or other electronic means may be connected to the network 140 through a networked computer or other networked device.

Data that is communicated from the users 110b through the network 140 may be automatically input to the server 150 or the database 170. The data may then be optionally reviewed by an operator 160. Such a review may be performed to confirm that the data is formatted correctly, or to verify that the data is substantively correct. Alternatively, the data that is communicated from the users 110b through the network 140 may be received by an operator 160. In one embodiment, the operator 160 reviews the data and corrects it as needed, then electronically transmits the data to the server 150 or the database 170. In an alternative embodiment, the operator 160 reads the data and manually inputs the data through an input device operably connected to the server 150 or database 170.

Data stored on the server 150 or the database 170 may be subsequently updated in the same fashion. For example, if a tool is moved to a new location, or if repair, calibration, or other maintenance is performed, the data sets associated with that information may be updated. Updates to a data set may include re-writing a data set and erasing the prior data set. Alternatively, updates to a data set may include writing new data to the data set without erasing prior data.

After the data is stored on the server 150 or database 170, logic associated with the server 150 or database 170 determines a future maintenance event, such as a future calibration date for the tool. The future maintenance event is also stored in the server 150 or the database 170. In one embodiment, the future maintenance event was entered as part of the original data set, and the logic simply reads the data. In an alternative embodiment, the logic calculates the future maintenance event based on the maintenance history data. For example, a regulatory body may set a certification standard for torque wrenches, requiring the torque wrench to be calibrated at predetermined intervals to maintain a certification status. In this example, the logic calculates the future maintenance event according to the most recent calibration date and the predetermined interval. In another example, regular maintenance may be recommended for a tool at suggested intervals. In such an example, the logic calculates the future maintenance event according to a most recent maintenance date and the suggested interval.

In one embodiment, the logic adjusts the future maintenance event so that it falls on a business day. For example, if the future maintenance event would fall on a weekend, the logic may adjust the future maintenance event such that it falls on the preceding Friday. Alternatively, the logic may adjust the future maintenance event such that it falls on the following Monday. The logic may make similar adjustments for holidays, or other days of business closure.

Logic associated with the server 150 or database 170 also monitors the data and the current date. At predetermined intervals, the logic will identify a current date, and identify data sets having a future maintenance event that is within a predetermined period of time of the current date. In one embodiment, the logic will perform this task on a daily interval. In alternative embodiments, the logic may perform this task on a weekly, monthly, quarterly, or other interval.

In one embodiment, the logic identifies data sets having a future maintenance event that is within one month of the current date. In alternative embodiments, the logic identifies data sets having a future maintenance event that is within one week or two weeks of the current date. The logic may also identify data sets having a future maintenance event that is past due.

Upon determining that the future maintenance event is within the predetermined period of time of the current date, the logic initiates a transmission of a notification to the associated user of the associated tool. In one embodiment, the logic initiates the transmission of a notification by providing a signal to the tracking service provider 120 of the future maintenance event. After receiving the signal, an individual from the tracking service provider 120 notifies the associated user by placing a telephone call, sending a facsimile, sending an email, making a personal visit, posting a notification on a website, sending a short message service (SMS) message, sending a multimedia messaging service (MMS) message, sending an instant message (IM), or sending a message through a postal service.

In an alternative embodiment, instead of, or in addition to providing a signal to the tracking service provider 120, the logic initiates the transmission of a notification directly to the user by placing an automated telephone call, sending an automated facsimile, sending an automated email, posting an automated notification on a website, sending an automated SMS message, sending an automated MMS message, sending an automated IM, or sending an automated message through a postal service.

It should be understood that a plurality of notification devices may be employed to provide notification to the user. Such notification devices include, without limitation, a telephone, a printer, and a facsimile machine. In one embodiment, a user may select one or more preferred methods of communication, and the notification is sent according to the selected method.

In one embodiment, a unique notification is transmitted to an associated user for each associated tool. In such an embodiment, if one user owns 20 torque wrenches that require calibration within a month, the user receives 20 separate notifications, each associated with a single torque wrench. In an alternative embodiment, a batch notification is sent to each user, where the batch notification identifies all of the tools associated with that user having a future maintenance event within a predetermined period of time of the current date. In such an embodiment, if one user owns 20 torque wrenches that require calibration within a month, the user receives one notification identifying all 20 torque wrenches.

In one embodiment, each time the logic identifies data sets having a future maintenance event that is within a predetermined period of time of the current date, it will initiate transmission of a notification. For example, if the logic monitors the data sets every day, and determines that a specific tool requires maintenance within a month, it will initiate transmission of a notification every day to the associated user of the specific tool until the maintenance history data is updated to show that the required maintenance has been performed.

In an alternative embodiment, the logic will initiate transmission of notifications at predetermined intervals. For example, the logic may initiate a first transmission when the future maintenance event for a specific tool is within one month of the current date, and then initiate a second transmission when the future maintenance event for the specific tool is within two weeks of the current date, and initiate a third transmission when the future maintenance event for the specific tool is within one week of the current date. The logic may also initiate transmission of a notification in when a future maintenance event is past due.

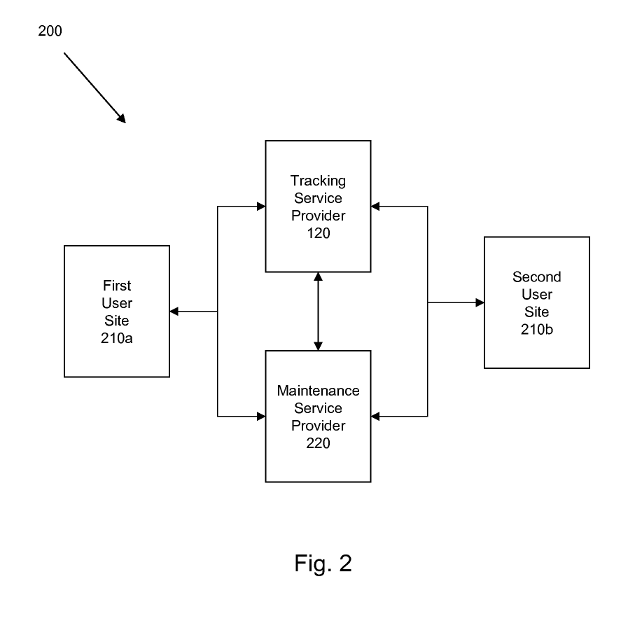

FIG. 2 is a schematic drawing of one embodiment of a tool tracking network 200 that illustrates exemplary paths that a tool may take in receiving maintenance, such as calibration. In the illustrated embodiment, one of the users 110a,b has a plurality of locations including at least a first user site 210a and a second user site 210b. In one embodiment, upon receiving a notification from the tracking service provider 120 that a tool at the first user site 210a requires maintenance or calibration, a user sends the tool from the first user site 210a to the tracking service provider 120, using any known shipping means. Alternatively, the tracking service 120 may send an individual to the first user site 210a to retrieve the tool. When the tracking service 120 takes possession of the tool, it may update the location data for that tool using any of the means described above.

After the tracking service provider 120 takes possession of the tool, it sends it to a tool maintenance service provider 220, where the maintenance or calibration is performed. When the tool maintenance service provider 220 takes possession of the tool, the location data for that tool is again updated using any of the means described above.

In an alternative embodiment, the user sends the tool directly from the first user site 210a to the tool maintenance service provider 220. In another alternative embodiment, the tool maintenance service provider 220 travels to the first user site 210a to take possession of the tool, or to perform the identified maintenance or calibration at the first user site 210a. In yet another alternative embodiment, the tool maintenance service provider 220 and the tracking service provider 120 are the same entity.

The tool maintenance service provider 220 performs the identified maintenance or calibration. After performing the maintenance or calibration, the maintenance history data is updated using any of the means described above to write new maintenance or calibration data to the maintenance history data.

In one embodiment, the tool maintenance service provider 220 is certified by a regulatory body, and issues a certificate of calibration after calibrating the tool. The tool maintenance service provider 220 may also issue certificates for other types of maintenance.

In one embodiment, the tool maintenance service provider 220 may send the certificate to the user. The certificate may be sent in paper form, or it may be electronically transmitted. Additionally, or in an alternative embodiment, the tool maintenance service provider 220 sends a certificate to the tracking service provider 120, in either an electronic or paper format.

Where the tracking service provider 120 receives the certificate, it may copy the certificate and send the original certificate or the copy of the certificate to the user. In one embodiment, the tracking service provider 120 makes a paper copy of the certificate. In an alternative embodiment, the tracking service provider 120 makes an electronic copy of the certificate.

The tracking service 120 may also store the original certificate or the copy of the certificate in a physical storage unit or in a database. In one example, the tracking service 120 stores an electronic copy of the certificate in the server 150 or the database 170, such that a user may view the electronic copy by accessing the server 150 through the network 140 via a website, a portal, or other means. The electronic certificate may be encrypted, password protected, or stored according to other security protocols.

After the tool maintenance service provider 220 has performed the maintenance or calibration, it returns the tool to the first user site 210a. In an alternative embodiment, the tool maintenance service provider 220 notifies the user that the maintenance or calibration is complete, and the user retrieves the tool. In another alternative embodiment, where the user has multiple locations, the user may designate a return site. In such an embodiment, the user may designate the first user site 210a or a second user site 210b. The user may make the designation at the time it sends the tool for maintenance or calibration, or at a later time, such as upon notification that the maintenance or calibration is complete.

After the user takes possession of the tool at one of the first user site 210a or the second user site 210b, the location data associated with the tool is updated according to one of the manners described above.

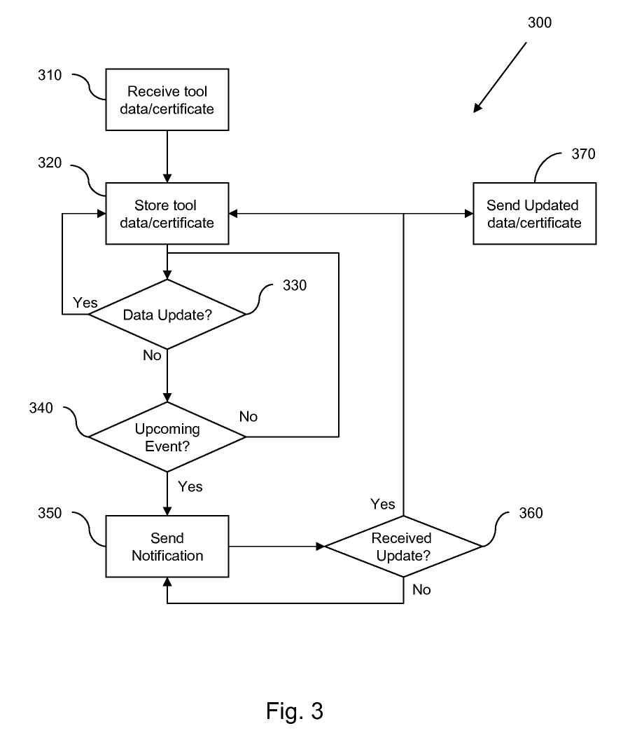

FIG. 3 is a flowchart illustrating an exemplary method 300 for tracking data related to a tool. Such a method may be performed by the tracking service provider 120.

The tracking service provider 120 receives, at a computer, data related to a tool according to one of the manners described above (at 310). The tool may be one of a plurality of tools. Specifically, the tool may be one of a plurality of torque wrenches.

The data may be in the form of a data set, and include a unique identifier associated with the tool, an associated user, location data associated with a first user location, and maintenance history data, such as calibration history data. The tracking service provider 120 may also receive a certificate of calibration, or other certificate (at 310). The certificate may be an original or a copy, and may be in a tangible or electronic form.

The tracking service provider 120 stores the data related to the tool and/or the certificate (at 320). If the tracking service provider 120 receives updated data or an updated certificate (at 330), it stores the updated data or certificate (at 320). In one embodiment, when the tracking service provider 120 receives an updated certificate, it retrieves new calibration data from the certificate. In one embodiment, the tracking service provider 120 stores the updated data by over-writing the previously stored data. In an alternative embodiment, the tracking service provider 120 stores the updated data without over-writing the previously stored data.

The tracking service provider 120 also identifies a future maintenance event, such as a future calibration date, and a current date. In one embodiment, the tracking service provider 120 identifies the future maintenance event by calculating the future maintenance event based on the maintenance history data. In an alternative embodiment, the tracking service provider 120 identifies the future maintenance event by reading it from the data set. After identifying the future maintenance event, the tracking service provider 120 stores the future maintenance event in the data set, if it was not previously stored.

The tracking servicer provider 120 also identifies a current date. When the date of the future maintenance event is within a predetermined period of time of the current date (at 340), the tracking service provider 120 sends a notification to an associated user (at 350). The notification may be sent by making a manual phone call, making an automated phone call, transmitting an email notification, transmitting a facsimile notification, posting a notification on a website, transmitting an SMS message, transmitting an MMS message, transmitting an IM, or transmitting a postal notification.

If the tracking service provider 120 receives updated data or an updated certificate (at 360) it stores the updated data or the updated certificate (at 320). The tracking service provider 120 also transmits the updated data or certificate to the user (at 370). The updated data may include updated maintenance history data, such as new calibration data, updated location data, such as new location data associated with a maintenance service provider or new location data associated with a first or second user location. The updated certificate may include an updated certificate of calibration or an updated certificate of maintenance.

After receiving an updated certificate, the tracking service provider 120 may also make a copy of the certificate. The copy may be a tangible copy or an electronic copy.

If the tracking service 120 does not receive updated data or an updated certificate (at 360) within a predetermined period of time, it sends another notification (at 350) using one or more of the transmission methods described above. The tracking service provider 120 may continue to send notifications until updated data is received, until a predetermined number of notifications have been sent, or until a predetermined period of time has passed.

After the tracking service 120 stores the updated data or the updated certificate (at 320), the process is repeated.

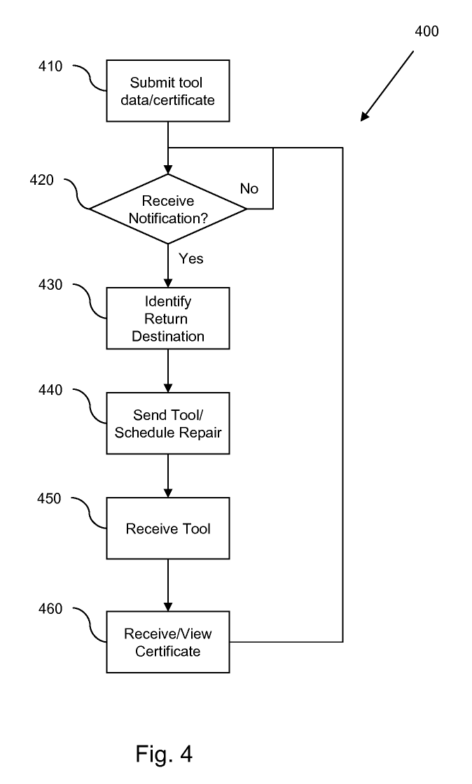

FIG. 4 is a flow chart illustrating an exemplary method for maintaining a tool that may be performed by a user 110a, 110b. The user submits data related to a tool according to one of the manners described above (at 410). The data may be in the form of a data set, and include a tool identifier, an associated user, location data, and maintenance history data. The user 110a, 110b may also submit a certificate of calibration, or other certificate (at 410). The certificate may be an original or a copy, and may be in a tangible or electronic form.

The user 110a,b then waits to receive a notification at 420. Receipt of the notification may occur in the form of receiving a manual phone call, receiving an automated phone call, receiving an email notification, receiving a facsimile notification, viewing a notification on a website, receiving an SMS message, receiving an MMS message, receiving an IM, or receiving a postal notification.

After receiving the notification, the user 110a,b may optionally identify a return destination for the tool (at 430). The user also sends the tool for maintenance or calibration or schedules an appointment for the maintenance or calibration (at 440). After maintenance or calibration is performed, the user receives the tool (at 450). The user 110a,b may also receive a certificate of calibration or other certificate or may view a copy of the certificate (at 460). The user 110a,b then waits for another notification (at 420).

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method for tracking a status of a plurality of torque wrenches for a plurality of users, the method comprising:
receiving, at a computer, data related to a torque wrench, the data including a unique identifier, an associated user, location data associated with a first user location, and calibration history data;
calculating a future calibration date for the torque wrench based on the calibration history data;
storing the data related to the torque wrench and the future calibration date in a database;
identifying a current date;
transmitting a notification to the associated user upon determining that the current date is within a predetermined period of time of the future calibration date;
receiving first updated location data associated with a maintenance service provider;
storing the first updated location data in the database;
receiving a certificate of calibration;
receiving new calibration data;
creating updated calibration history data by writing the new calibration data to the calibration history data;
storing the updated calibration history data in the database;
transmitting the updated calibration history data to the associated user;
receiving second updated location data associated with a second user location; and
storing the second updated location data in the database.

2. The method of claim 1, wherein the first user location is different from the second user location.

3. The method of claim 1, wherein the first user location is the same as the second user location.

4. The method of claim 1, wherein the receiving new calibration data includes retrieving new calibration data from the certificate of calibration.

5. The method of claim 1, further comprising creating a copy of the certificate of calibration.

6. The method of claim 5, further comprising transmitting one of the certificate of calibration and the copy of the certificate of calibration to the associated user.

7. The method of claim 5, further comprising storing one of the certificate of calibration and the copy of the certificate of calibration.

8. The method of claim 1, wherein the receiving, at a computer, data related to a torque wrench includes receiving data by manual input of an operator.

9. The method of claim 1, wherein the receiving, at a computer, data related to a torque wrench includes receiving data through a network.

10. The method of claim 1, wherein the transmitting a notification to the associated user includes at least one of making a manual phone call, making an automated phone call, transmitting an email notification, transmitting a facsimile notification, posting a notification on a website, transmitting a short message service message, transmitting a multimedia messaging service message, transmitting an instant message, and transmitting a postal notification.

11. The method of claim 1, further comprising receiving the torque wrench, calibrating the torque wrench, and sending the torque wrench to the second user location.

12. The method of claim 1, further comprising repeating the transmitting the notification to the associated user at a predetermined interval.

13. A method for tracking a status of a plurality of tools for a plurality of users, the method comprising:
receiving, at a computer, data related to a tool, the data including:
a tool identifier,
an associated user,
location data, and
maintenance history data;
storing the data related to the tool in a database;
identifying a date of a future maintenance event;
transmitting a notification to the associated user when the date of the future maintenance event is within a predetermined period of time of a current date;
receiving updated location data;
storing the updated location data in the database;
receiving updated maintenance history data; and
storing the updated maintenance history data in the database.

14. The method of claim 13, further comprising repeating the transmitting the notification to the associated user.

15. The method of claim 13, further comprising transmitting the updated location data to the associated user and transmitting the updated maintenance history data to the associated user.

16. The method of claim 15, wherein each of the transmitting a notification to the associated user, the transmitting the updated location data to the associated user, and the transmitting the updated maintenance history data to the associated user includes at least one of: making a manual phone call, making an automated phone call, transmitting an email notification, transmitting a facsimile notification, posting a notification on a website, transmitting a short message service message, transmitting a multimedia messaging service message, transmitting an instant message, and transmitting a postal notification.

17. A system for tracking a status of a plurality of tools for a plurality of users, the system comprising:
an input device configured to receive a plurality of data sets, each data set being associated with one of the plurality of tools and including:
a unique identifier,
location data, and
maintenance history data;
a database operably connected to the input device and configured to store the plurality of data sets;
logic configured to identify a future maintenance event for each of the plurality of tools based on the maintenance history data in each data set;
a notification device configured to transmit notification to a user of a future maintenance event, wherein the notification device is selected from the group consisting of a computer in data communication with a network, a telephone, a printer, and a facsimile machine; and
a copying device configured to create a copy of a maintenance certificate.

18. The system of claim 17, wherein the input device is a computer configured to receive input from an operator.

19. The system of claim 17, wherein the input device is a server operably connected to a network, and configured to receive input from remote users.

20. The system of claim 17, wherein the copying device is configured to create an electronic copy of the maintenance certificate.
